(19) United States
(12) Patent Application Publication
(10) Pub. No.: US 2006/0286506 A1
(43) Pub. Date: Dec. 21, 2006

(54) Dental bur with use history recording rings and method of recording the number of uses of a dental bur

(76) Inventor: Mark D. Birnholtz, West Bloomfield, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/443,977

(22) Filed: May 31, 2006

Related U.S. Application Data
(60) Provisional application No. 60/691,136, filed on Jun. 16, 2005.

(51) Int. Cl. A61C 3/02

(52) U.S. Cl. 433/165

(57) ABSTRACT

A method of making and using a dental tool that is recommended to be reused a certain number of times is provided with markings on the shaft of the tool that correspond in number to the number of recommended uses of the tool. A visually perceptible marking, such as paint or ink may be applied to annular recesses or to a portion of the shaft surface that is not recessed. One of the markings is removed from the shaft of the tool prior to reusing the tool. The dental tool of the present invention has a cutting element and a shaft that is provided with a plurality of deposits or indicators applied to the shaft.

### CROSS-REFERENCE TO RELATED APPLICATIONS

This application claims the benefit of U.S. provisional application Ser. No. 60/691,136 filed Jun. 16, 2005.

### BACKGROUND OF THE INVENTION

1. Technical Field

The present invention relates to multiple use dental burs.

2. Background Art

Dentists use hand pieces that are adapted to receive dental drill bits, burs or other cutting instruments. Teeth are drilled or ground to remove decay, perform root canal procedures, and shape teeth or root canals. A wide variety of dental drill bits or burs are available. Some examples of dental drill bits and burs include diamond burs, carbide burs, steel burs, post drills, root canal preparation burs or drills, mandrels for laboratory work, polishing wheels, polishing stones, and polishing tips.

While some drills and burs are intended for single use and are then disposed of, most are recommended to be used a limited number of times and are sterilized between uses. If a dental tool is disposed of before it has been used its rated number of times, excessive tool replacement costs may be incurred. For example, post drills may be reused ten or more times, diamond burs may be used six or more times with some being usable up to ten times. If a dental bur is reused more than the recommended number of times, the bur may become dull. Dull drill bits and burs may damage the tooth or pulp. It is difficult, if not impossible, to visually determine the extent of use of a dental drill or bur. A dentist cannot normally determine by merely looking at a dental bur or drill whether a tool bit has exceeded its useful life.

There is a need for a simple and effective method and apparatus for determining the number of times a dental drill or bur has been used. For any such method or apparatus to be effective, it must be simple to use and must also be unaffected by high speed drilling operations and sterilization procedures.

### SUMMARY OF THE INVENTION

According to one aspect of the present invention, a dental tool such as a bur, drill, mandrel or polishing tool is marked so that the number of uses of the tool can be quickly determined by a simple visual inspection. In one embodiment of the invention, painted rings may be provided on the shaft of the tool that correspond to the rated number of uses recommended for the tool. After each use, a ring may be removed by a dental technician using an explorer or hand excavator. Ink jet or other ink markings on the shaft surface can be removed by any dental polishing instrument, such as a rubber wheel polishing tool. This can be done by a dental technician without requiring any time on the part of a dentist. The dentist could then simply visually inspect the shaft of the tool prior to inserting the tool into the high speed hand piece and know that the tool is within the tool's normal rated number of uses.

Other aspects of the invention include providing the rings within an area of the shaft of the tool that is protected during drilling operation by the tool collet. Alternatively, the removable marking may be applied to a portion of the shaft that remains visible when the tool is received in a collet. Another aspect of the invention is that annular or other shaped recesses may be provided in the shaft of the tool to receive a semi-permanent deposit that may be selectively removed to log usages of the tool. The deposit may be paint, ink, or another material.

Referring to another embodiment of the present invention, a dot, numeral, letter, or other indicator may be provided on the shaft of the tool that may be removed to log each use of the tool. Such indicators may be provided on the shaft exterior surface or may be applied in a recess formed on the shaft.

According to another aspect of the present invention, a method is provided for use logging dental tools. The method requires use of a specially marked tool shaft that includes indicia that may be selectively removed between one use and another use as part of the tool recycling/sterilization procedure.

According to another aspect of the invention, a method of using a dental tool having a plurality of visually perceptible indicia on the shaft of the tool is provided. The method includes performing a first dental procedure using the tool after which the tool is sterilized. One of the indicia is removed from the shaft of the tool and then a second dental procedure is performed using the tool.

According to other aspects of the method of using the dental tool, the method is repeated until all of the indicia are removed from the shaft of the tool at which time the tool may be discarded. The method may further comprise forming a plurality of recesses on the shaft of the tool and depositing visually perceptible coating deposits in the recesses. The step of removing one of the markings may further comprise picking off the marking with a hand tool, such as an explorer or hand excavator. The dental tool may be a dental bur, drill, mandrel, polishing tool, or the like. The shaft of the tool used in the method may have a first portion that is received in a collet of a power driven hand piece with a second portion of the shaft extending from the collet wherein the markings are provided on the first portion of the shaft.

According to another aspect of the invention, a method of making and using a dental tool is provided for a dental tool that has a shaft and a cutting element. A visually perceptible indicator is applied to the shaft. The dental tool is used to perform a dental procedure after which the dental tool is sterilized. After each use, a single indicator is removed from the shaft of the tool and the tool is then reused.

According to other aspects of the method of making and using a dental tool, the steps of sterilizing the dental tool, removing a single indicator, and reusing the dental tool are repeated until all of the deposits are removed. After all of the deposits are removed, the tool may be discarded. A plurality of recesses may be formed on a portion of the shaft of the tool that is received in a collet of a hand piece. The step of inserting the dental tool in the collet protects the indicators because they are shielded by the collet. The recesses may be either a plurality of spaced dots or annular recesses that extend around the circumference of the shaft with the coating deposits being applied in the form of a plurality of annular rings. The indicators may be a paint composition that has limited adhesive properties, wherein the indicators are cohesive so that during the removing step the indicators are easily removed from the shaft of the dental tool.

According yet to another aspect of the invention, a dental tool is provided for removing material that is reusable for a limited number of procedures. The dental tool comprises a shaft on which a plurality of indicators are applied. The indicators adhere to the shaft to a limited extent to facilitate mechanical removal thereof. A cutting element is provided at least at a distal end of the shaft that is reusable a plurality of times corresponding to the number of indicators provided on the shaft.

According to other aspects of the invention as they relate to the dental tool, an annular recess having a deposit of a second type of indicating material that adheres to the annular recess in the shaft to a greater extent than the plurality of deposits of indicating material previously referenced. The indicators may be pigmented coatings that are applied to recesses in the shaft. The cutting element may be a bur cutting element, a drill cutting element, a mandrel, or a polishing tool.

According to other aspects of the invention as they relate to the dental tool, the plurality of indicators are provided on a portion of the shaft that is received in a collet of a power driven hand piece. A tool identification ring may be provided on the shaft at a portion of the shaft that is not received in the collet of the hand piece. The tool identification ring may be an annular painted ring on the shaft of the tool. The plurality of recesses and plurality of deposits may be arranged to form a row of dots.

These and other aspects of the present invention will be better understood in view of the attached drawings and the following detailed description of the invention.

### BRIEF DESCRIPTION OF THE DRAWINGS

FIG. 1 is a perspective view of a high speed dental hand piece with a dental bur positioned over a tooth;

FIG. 2 is a elevation view of a dental bur having a plurality of use logging rings;

FIG. 3 is a cross section view taken along line 3-3 in FIG. 2;

FIG. 4 is a perspective view of a dental bur having a plurality of use logging rings with one of the rings partially removed by an explorer tool; and

FIG. 5 is a perspective view of an alternative embodiment of a dental bur having selectively removable dots for logging tool usage.

### DETAILED DESCRIPTION OF THE PREFERRED EMBODIMENT(S)

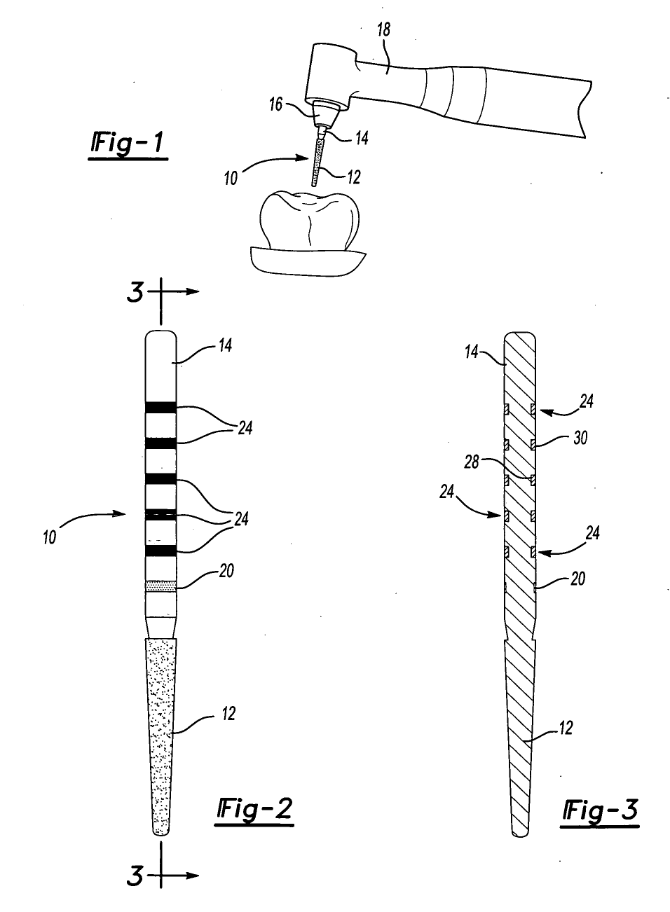

Referring to FIG. 1, a dental tool 10 is illustrated that comprises a diamond bur. The dental tool 10 could be a diamond bur, carbide bur, steel bur, or root canal preparation bur. Alternatively, the present invention may be provided on a drill and other reusable rotary tool insert used by dentists that have a limited life.

The dental tool 10 includes a tip 12 that is secured to one end of a shaft 14. The shaft 14 is received in a collet 16 of a hand piece 18.

Referring to FIG. 2, the dental tool 10 is shown in greater detail. The dental tool 10 includes a bur tip 12 that is secured to one end of the shaft 14. An identification ring 20 is provided on the shaft 14 near the tip 12. The identification ring 20 may be positioned outside of the collet 16 of the high speed hand piece 18. A plurality of removable rings 24 are provided along the shaft 14.

Referring to FIGS. 2 and 3, the removable rings 24 are provided on the shaft 14 by forming an annular recess 28 in the shaft in which paint, ink, ceramic, plastic, or another indicator may be deposited to provide a readily visible indication of the number of times that the tool 10 has been used. Depending in part upon the composition of the rings, the rings may be provided on a non-recessed portion of the shaft 14. The compound 30 in the annular recess 28 is a material that is semi-permanently adhered to the annular recess 28 so that it does not become dislodged from the annular recess 28 by normal operation of the high speed hand piece 18, but can be easily and fully removed with an explorer 32.

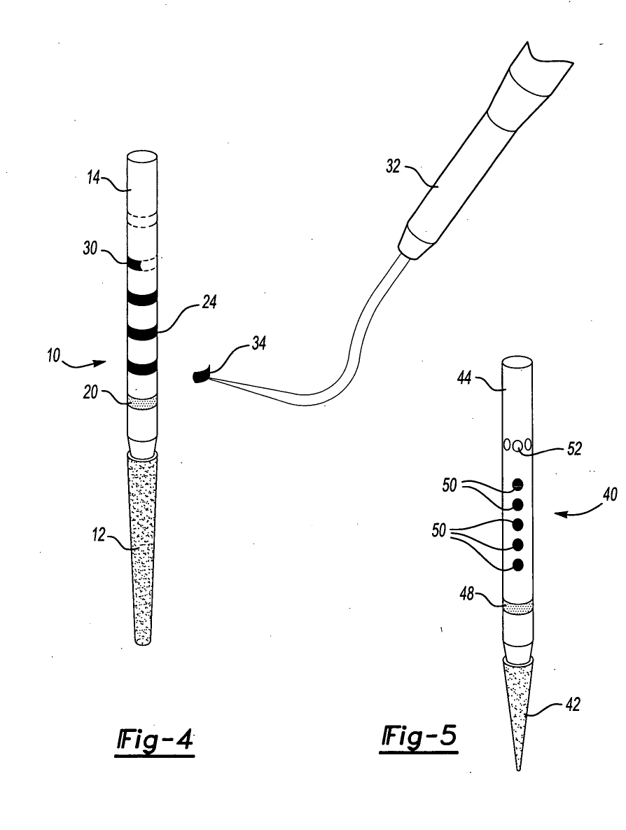

Referring to FIG. 4, the dental tool 10 is shown in combination with the explorer 32. The explorer 32 is shown in the process of removing one of the removable rings 24 from the shaft 14 of the tool. Instead of the explorer 32, a hand excavator or other hand tool could be used. The shaft 14 of the tool is a plain cylindrical shaft. The portion of the shaft 10 previously coated with the paint or ink is exposed after the first removable ring 24 is removed from the shaft 14. In FIG. 4, the second removable ring is partially removed and the explorer 32 is shown with a ring fragment 34 on the tip of the explorer 32. The dashed lines shown in FIG. 4 are intended to illustrate the exposed portions of a plain cylindrical shaft 14 after the removable ring 24 is removed.

According to the method of the present invention, a dentist may use the dental tool 10 to perform a drilling operation in the normal manner. After completion of the drilling operation, the tool 10 is removed from the collet 16 of the high speed hand piece 18 and placed on a tray. The tool 10 is then autoclaved for sterilization prior to reuse. While autoclaving is the normal sterilization procedure, other sterilization procedures could be used. A dental assistant or other person may use an explorer 32 or hand excavator to pick the compound 30 off of the shaft 14, either before sterilization or after sterilization, to indicate another use of the tool 10. A rotary tool such as a rubber wheel could also be used to remove the shaft marking or ring. For example, the dental bur 10 may have five removable rings 24 and would be one that is intended to be used five times prior to disposal. When the tool 10 is returned to the dentist for reuse, the dentist can immediately determine the number of times that the tool still may be used within the manufacturer's specification by counting the number of rings 24 remaining on the shaft 14.

Referring to FIG. 5, an alternative embodiment is shown wherein a dental drill 40 is illustrated that includes a drill tip 42 that is secured to or formed as a part of the shaft 44 of the drill 40. An identification ring 48 may be included to identify the size or source of the drill 40. A plurality of removable dots 50 are shown on the shaft 44. The removable dots 50 may be provided in a circular recess 52 or may be merely applied directly to the surface of the shaft 14. As illustrated in FIG. 5, two sets of removable dots 50 are illustrated with one set being in an axial line and another being in a circumferential ring. This illustration is intended to show that any arrangement could be provided on the shaft 44. As shown in FIG. 5, several of the circular recesses 52 are shown with their dots 50 removed. Letters, numerals or other symbols could be used in different embodiments of the invention in place of the rings 24 or dots 50.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of using a dental tool having a plurality of visually perceptible markings on the shaft of the tool, the method comprising:
performing a first dental procedure using the tool;
sterilizing the tool;
removing one of the markings from the shaft of the tool; and
performing a second dental procedure using the tool.

2. The method of claim 1 further comprising repeating the method until all of the markings are removed from the shaft of the tool and then disposing of the tool.

3. The method of claim 1 further comprising:
forming a plurality of recesses on the shaft of the tool; and
depositing paint in the recesses.

4. The method of claim 1 wherein the step of removing one of the markings further comprises removing the marking with a hand tool.

5. The method of claim 4 wherein the visually perceptible marking is selected from the group consisting essentially of a paint or an ink.

6. The method of claim 1 wherein the dental tool is a dental bur.

7. The method of claim 1 wherein the shaft of the tool has a first portion that is received in a collet of a power driven hand piece and a second portion that extends from the collet, and wherein the markings are provided on the first portion of the shaft.

8. A method of making and using a dental tool comprising:
providing a dental tool that has a shaft and a cutting element;
applying visually perceptible indicia to the shaft;
using the dental tool to perform a dental procedure;
sterilizing the dental tool;
removing a single one of the indicia from the shaft of the tool; and
reusing the dental tool.

9. The method of claim 8 wherein the steps of sterilizing the dental tool, removing a single one of the indicia, and reusing the dental tool is repeated until all of the indicia are removed, and wherein the tool is discarded after all of the indicia are removed.

10. The method of claim 8 further comprising forming a plurality of recesses to which the visually perceptible coating deposits are applied on a portion of the shaft of the dental tool that is received in a collet of a hand piece, and further comprising the step of inserting the dental tool in the collet of the hand piece with the indicia being protected by the collet.

11. The method of claim 10 wherein the recesses are spaced and wherein the indicia are applied in the form of a plurality of dots.

12. The method of claim 10 wherein the recesses are annular recesses that extend around the circumference of the shaft and wherein the indicia are applied in the form of a plurality of annular rings.

13. The method of claim 8 wherein the indicia are a paint composition that has limited adhesive properties and wherein the coating deposits are cohesive so that in the removing step the paint composition is easily removed from the shaft of the dental tool and forms agglomerations of the paint composition.

14. The method of claim 8 wherein the step of applying visually perceptible indicia further comprises applying a marking to the shaft of the tool that adheres to the shaft but is selectively removable from the shaft.

15. A dental tool for removing material that is reusable for a limited number of procedures, the dental tool comprising:
a shaft;
a plurality of discrete indicators provided on the shaft, wherein the indicators adhere to the shaft to a limited extent to facilitate mechanical removal thereof; and
a cutting element provided at least at a distal end of the shaft that is reusable a plurality of times that corresponds to the number of indicators provided on the shaft.

16. The dental tool of claim 15 further comprising an annular recess that has a deposit of a second type of indicating material that adheres to the annular recess in the shaft to a greater extent than the plurality of indicators.

17. The dental tool of claim 16 wherein the indicators are pigmented coatings that are applied to recesses in the shaft.

18. The dental tool of claim 15 wherein the cutting element is selected from the group consisting essentially of: a bur cutting element; a drill cutting element, a mandrel, or a polishing tool.

19. The dental tool of claim 15 wherein the plurality of indicators are provided on a portion of the shaft that is received in a collet of a power driven hand piece.

20. The dental tool of claim 19 further comprising a tool identification ring that is provided on the shaft at a portion of the shaft that is not received in the collet of the hand piece.

21. The dental tool of claim 20 wherein the tool identification ring is an annular painted ring on the shaft of the tool and the plurality of indicators are arranged to form a row of dots.
